(19) United States
(12) Patent Application Publication
(10) Pub. No.: US 2023/0126821 A1
(43) Pub. Date: Apr. 27, 2023

(54) SYSTEMS, DEVICES AND METHODS FOR THE DYNAMIC GENERATION OF DIALOG-BASED INTERACTIVE CONTENT

(71) Applicant: Vigeo Technologies, Inc., New York, NY (US)

(72) Inventors: Victor Gao, Delray Beach, FL (US); Adam Berger, Woodcliff Lake, NJ (US)

(73) Assignee: Vigeo Technologies, Inc., New York, NY (US)

(21) Appl. No.: 17/996,769

(22) PCT Filed: Apr. 23, 2021
(86) PCT No.: PCT/US2021/028770

§ 371 Date: Oct. 20, 2022

Related U.S. Application Data
(60) Provisional application No. 63/014,348, filed on Apr. 23, 2020.

(51) Int. Cl. G06F 40/205; G06F 40/30

(52) U.S. Cl. CPC G06F 40/205; G06F 40/30

(57) ABSTRACT

Systems, devices, and method disclosed herein are generally directed to dynamic generation of dialog-based interactive content that emulates human-like behavior during a sequence of bilateral digital text-based exchanges with the user. The dialog-based interactive content can be grown in real-time based upon the user's interactions with another human entity, and can be specified wholly via a serialized representation, disclosed herein as a vDialog Markup Langua ge (vDML).

### CROSS-REFERENCE TO RELATED APPLICATIONS

This application claims priority to, and the benefit of, U.S. Application No. 63/014,348, entitled “SYSTEMS, DEVICES AND METHODS FOR THE DYNAMIC GENERATION OF DIALOG-BASED INTERACTIVE CONTENT,” filed on Apr. 23, 2020, the disclosure of which is incorporated herein by reference in its entirety.

### BACKGROUND

With the innovations in digital technology, digital interactive content has become ubiquitous. From video games, quizzes, ebooks, interactive television, digital advertising, and other software applications, interactive content enables active engagement with and from users. The user becomes an integral part of a dynamic, two-way experience. By using interactive content and dialog, users can be provided with relevant, accessible information while keeping them engaged.

Indeed, businesses increasingly employ digital, dialog-based user communications as a means of gaining an edge over their competition. Customers that engage in dialog with a business may also spend more time engaging with other aspects of the business. This in turn positively impacts businesses by improving brand loyalty, repeat business, profitability, and general reputation—a kind of psychological moat that insulates a business from potential competition.

Conventional approaches that provide such bilateral digital interactions are usually either 1) pre-programmed, by engineers, of possible interactions (e.g., an SMS answering service), or 2) generated from existing corpora of word associations (e.g., a chatbot running on a website). Both approaches can be highly inefficient for the following reasons. One, machine-generated dialog is notoriously unhuman-like. No machine has been able to consistently fool a human being into thinking she was speaking to another human. Two, contexts in which dialog with users are needed are highly dynamic and variable, and no amount of pre-programmed interactive dialogs can cover all possible scenarios. Three, massively pre-programmed dialogs are extremely unwieldy to debug and maintain. Four, these same contexts in which dialog with users is called for are constantly evolving—such as, for example, the addition of new users of different backgrounds/tastes/demographics, addition of new content, fast-changing business logic, and/or the like. These new interactions typically need to be addressed in application code, e.g., by coding a back-and forth dialog with the user for every possible user response. This can lead to scalability issues with the application code growing explosively unsustainably large with new and evolving interactions.

### SUMMARY

In some aspects, a method for dynamic modification of dialog-based interactive content associated with a set of target users, the dynamic modification being responsive to user input from one or more target users of the set of target users, includes receiving the specification of the interactive dialog for the set of target users, the interactive dialog structured as a directed graph. The directed graph includes a set of nodes, wherein each node represents content to be rendered to that target user via a display device of that target user. The directed graph also includes a set of edges, each edge of the set of edges being a directed edge connecting two nodes of the set of nodes, wherein each edge represents an anticipated user response of that target user to the content associated with an origin node of the two nodes. The method further includes transmitting, for rendering, to a first target user of the set of target users via a first user device associated with the first target user, content associated with a first node of the set of nodes, the first node being an origin node for one or more first edges of the set of edges. The method also includes receiving, responsive to the rendering of the content associated with the first node at the first user device, a first user input from the first target user via the first user device. The method further includes parsing the first user input to identify whether the first user input maps to any edge of the one or more first edges, and when the first user input does not map to any edge of the one or more first edges, communicating an indication of the content associated with the first node and the first user input to an author device of the author user. The method also includes receiving, from the author user, via the author device, and responsive to the communicating, a specification of an update to the directed graph. The specification of the update includes a specification of a second node to be incorporated into the set of nodes, the second node representing content to be rendered to the first user responsive to the first user input. The specification of the update also includes a specification of a second edge to be incorporated into the set of edges, wherein the first node is an origin node for the second edge and wherein the second node is a destination node of the set of edges, the second edge representing the first user input. The method further includes updating the directed graph based on the update received from the author user. The method further includes transmitting, for rendering, to the first target user via the first target device and responsive to the first user input, content associated with the second node.

In some aspects, a system for dynamic modification of dialog-based interactive content associated with a set of target users, the dynamic modification being responsive to user input from one or more target users of the set of target users, includes a controller. The controller is configured to receive the specification of the interactive dialog for the set of target users, the interactive dialog structured as a directed graph. The directed graph includes a set of nodes, wherein each node represents content to be rendered to that target user via a display device of that target user. The directed graph also includes a set of edges, each edge of the set of edges being a directed edge connecting two nodes of the set of nodes, wherein each edge represents an anticipated user response of that target user to the content associated with an origin node of the two nodes. The controller is further configured to transmit, for rendering, to a first target user of the set of target users via a first user device associated with the first target user, content associated with a first node of the set of nodes, the first node being an origin node for one or more first edges of the set of edges. The controller is further configured to receive, responsive to the rendering of the content associated with the first node at the first user device, a first user input from the first target user via the first user device. The controller is further configured to parse the first user input to identify whether the first user input maps to any edge of the one or more first edges, and when the first user input does not map to any edge of the one or more first edges, communicating an indication of the content associated with the first node and the first user input to an author device of the author user. The controller is further configured to receive, from the author user, via the author device, and responsive to the communicating, a specification of an update to the directed graph. The specification of the update includes a specification of a second node to be incorporated into the set of nodes, the second node representing content to be rendered to the first user responsive to the first user input. The specification of the update also includes a specification of a second edge to be incorporated into the set of edges, wherein the first node is an origin node for the second edge and wherein the second node is a destination node of the set of edges, the second edge representing the first user input. The controller is further configured to update the directed graph based on the update received from the author user. The controller is further configured to transmit, for rendering, to the first target user via the first target device and responsive to the first user input, content associated with the second node.

All combinations of the foregoing concepts and additional concepts are discussed in greater detail below (provided such concepts are not mutually inconsistent) and are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 illustrates a system for dynamic generation of dialog-based interactive content.

FIG. 2 illustrates an example of dialog-based interaction.

FIG. 3A illustrates another example of a ‘knock-knock joke’ dialog-based interaction.

FIG. 3B illustrates a directed graph representation of the dialog-based interaction of FIG. 3A, and the mechanism by which dialog-based interactions are auto-updated when new manual replies are issued.

FIG. 3C illustrates a serialized representation (i.e., a markup language) of the dialog-based interaction of FIG. 3A.

FIG. 4 illustrates another example markup-language representation of a more complex dialog-based interaction.

FIG. 5 illustrates an example of an overall interactive user experience including a combination of dynamically-generated web-based, app-based, and dialog-based interactions.

### DETAILED DESCRIPTION

Following below are more detailed descriptions of various concepts related to, and implementations of, systems, devices and methods for dynamic growth, extension, and/or generation of dialog-based interactive content based on past actual human interactions such as, for example, between a User and a Coach (also sometimes referred to as a “Live Author”, as described in greater detail herein). It should be appreciated that various concepts introduced above and discussed in greater detail below may be implemented in numerous ways. Examples of specific implementations and applications are provided primarily for illustrative purposes to enable those skilled in the art to practice the implementations and alternatives apparent to those skilled in the art.

The example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

Aspects of the systems, devices, and method disclosed herein are generally directed to dialog-based interactions with users/user devices. More specifically, systems, methods, and devices for generating and providing conversational, human-like digital interactions between the user and another entity (e.g., via the user's mobile device) is disclosed herein. In some implementations, methods for representing dialog-based interactive content that may be both pre-specified and grown in real-time—i.e., the vDialog Modeling Language (vDML) is disclosed herein.

In some implementations, the human-like behavior can be implemented using an intermix of automated interactions and manual interventions—where present manual interventions are transformed into future automated interactions—sometimes also referred to herein as “manumatic control”. More specifically, the bilateral digital interactions between the user and the other entity can mimic conversations between two humans. These digital interactions are hence relatively more (and perceivable by the user to be more) meaningful, personalized, and thoughtful than conventional human-machine interactions since most people still prefer human interaction when engaging with a business entity. In turn, businesses can be positively impacted (financially and otherwise) when customers spend more time engaging with them.

### System for Dynamic Generation of Dialog-Based Interactive Content

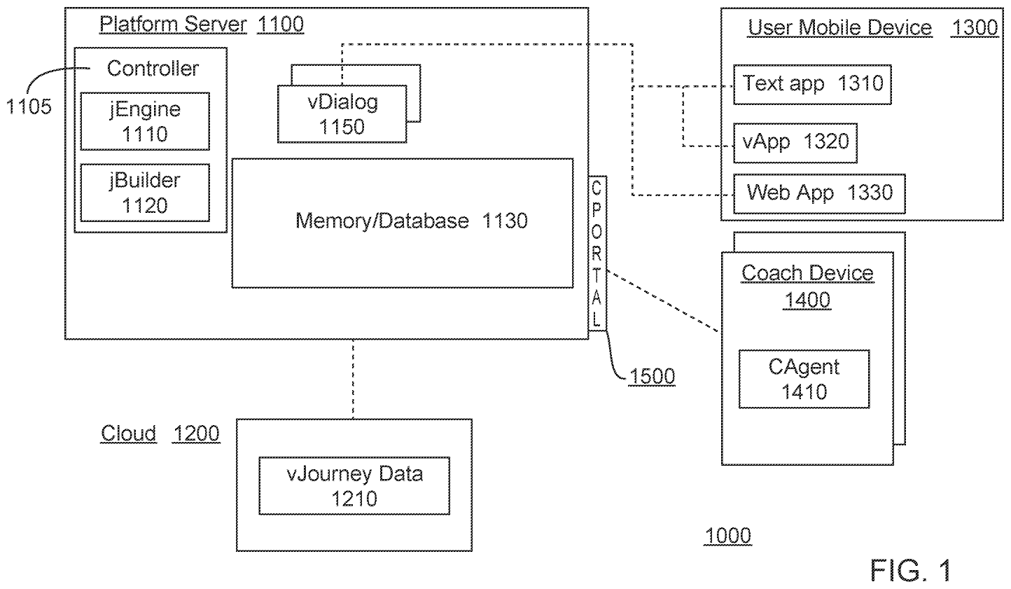

FIG. 1 is a schematic illustration of an environment/system 1000 in which dynamic generation of dialog-based interactive content can be implemented and/or carried out. The system 1000 includes a platform server 1100. The server 1100 can interact with storage 1200, illustrated herein as a cloud-based storage platform, for storing any data generated and/or consumed by the approaches detailed herein. The server 1100 can also interact with a mobile user device 1300, such as a Smartphone, to interactive content to the device 1300 as part of a dialog with the user of the device 1300, such as via a texting application 1310, a proprietary cloud-based application vApp 1320, other applications 1330 running on the device 1300 (e.g., a web browser application), and/or the like. The server 1100 can include components and/or be configured to provide dynamically generated interactive content using polymorphic elements, as generally disclosed in PCT Application No. PCT/US2020/029501 (the '501 application), the entire disclosure of which is incorporated herein by reference.

The server 1100 can also be in communication with a Coach device(s) 1400 (also sometimes referred to as an “Author device”) via a hardware and/or software interface referred to here as an CPortal 1500, also sometimes referred to as a ‘Coach Portal’. Each Coach device 1400 can connect to the CPortal 1500 to execute one or more actions that can enable an operator of the Coach device 1400, illustrated here as the CAgent 1410 (also sometimes referred to as a “Coach”, “Author”, “Coach user”, “Author user”, and variants thereof) to provide manual input, modification, dialog intervention information, etc. of any aspect of operation of the server 1000.

The server 1100 includes at least a controller 1105 and a memory/database 1130. Unless indicated otherwise, all components illustrated within the server 1100 can be in communication with each other. It will also be understood that the database and the memory can be separate data stores. In some embodiments, the memory/database 1130 can constitute one or more databases. Further, in other embodiments, at least one database can be external to the server 1100. The server 1100 can also include one or more input/output (I/O) interfaces (not shown), implemented in software and/or hardware, for other components of the server 1100, and/or external to the server 1100 and/or the system 1000, to interact with the server 1100.

The memory/database 1130 can encompass, for example, a random access memory (RAM), a memory buffer, a hard drive, a database, an erasable programmable read-only memory (EPROM), an electrically erasable read-only memory (EEPROM), a read-only memory (ROM), Flash memory, and/or so forth. The memory/database 1130 (referred to herein as the database 1130 for simplicity) can store instructions to cause the controller 1105 to execute processes and/or functions associated with the server 1100 and/or the system 1000. The database 1130 can store any suitable content for use with, or generated by, the system 1000 including, but not limited to, a time-stream of all dialog-, web-, and/or app-based interactions between the server 1100 and the user device 1300, a list of all the vDialogs 1150 (including different versions thereof), an indication of active (i.e., invoked, invokable, and/or in use) and inactive (i.e., un-invokable and/or not usable/selectable for use) vDialogs 1150, an indication of current state of a dialog-based interaction with a user such as, for example, a time-stream, 2-tuple of (user, vDialog)-pairs remembering which node of which vDialog 1150 a user is on (if any), components of vDialogs 1150 (e.g., vSnippets and vAgents, explained later). The vDialog 1150 is explained in greater detail herein.

The controller 1105 can be any suitable processing device configured to run and/or execute a set of instructions or code associated with the server 1100. The controller 1105 can be, for example, a general purpose processor, a Field Programmable Gate Array (FPGA), an Application Specific Integrated Circuit (ASIC), a Digital Signal Processor (DSP), and/or the like.

In some embodiments, all components of the server 1100 can be included in a common casing such as, for example, a single housing that presents the server 1100 as an integrated, one-piece device for a user. In other embodiments, at least some components of the server 1100 can be in separate locations, housings, and/or devices. For example, in some embodiments, the memory/database 1130 can be in a separate housing from the controller 1105 and be in communication via one or more networks, each of which can be any type of network such as, for example, a local area network (LAN), a wide area network (WAN), a virtual network, a telecommunications network, and/or the Internet, implemented as a wired network and/or a wireless network. Any or all communications can be secured (e.g., encrypted) or unsecured, as is known in the art. The server 1100 can be or encompass a personal computer, a server, a work station, a tablet, a mobile device, a cloud computing environment, an application or a module running on any of these platforms, and/or the like.

As illustrated in FIG. 1, the controller can execute components (i.e., can execute computer-executable instructions corresponding to functionality associated with) jEngine 1110 and jBuilder 1120. The jEngine 1110 can exchange dialog-based interactive content with the user device 1300 during operation such as, for example, via one or more text messages via a texting application (e.g., SMS, iMessage, WhatsApp) 1310, via one or more custom interfaces via the application vApp 1320, via one or more links to web applications 1330, and/or the like. Specifically, the jEngine 1110 exchanges dialog-based content via vDialog(s) 1150 based on timing/gating and other programmed and learned information specified by the vDialog itself, and/or by the CAgent(s) 1410. The jEngine 1110 also stores any user-specific information generated by vDialog(s) 1150 and/or other components in the cloud 1200.

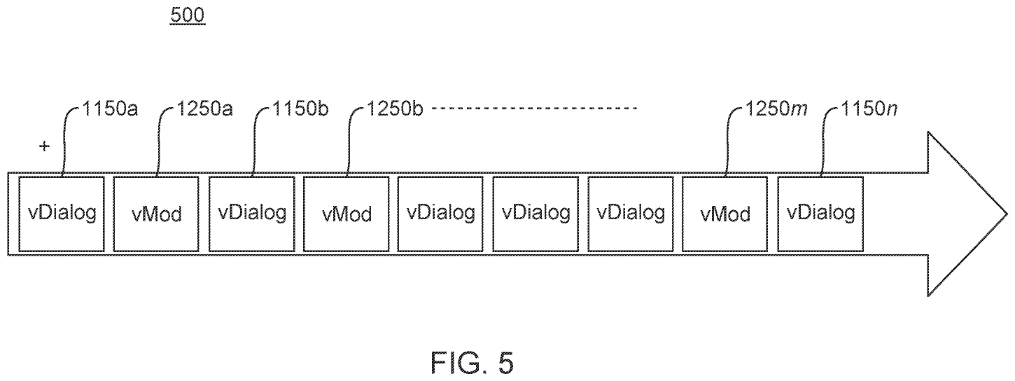

The jBuilder 1120 codes, builds, and maintains the underlying templates for all web-, app-, and dialog-based interactions along a vJourney (explained with greater detail with respect to FIG. 5), employed by creatives (e.g., Authors and/or Coaches) and specialists in the field or domain in which the vJourney operates. Specifically, the jBuilder 1120 can generate and/or specify both the vDialogs as well as vModule(s), and/or the like, for a specific vJourney. As explained in greater detail herein, vDialogs 1150 can be specified entirely via a markup language vDML, and the jBuilder 1120 can be configured to parse the vDML to build a particular vDialog, which can then be executed by the jEngine 1110 to interact with the user device 1300. Although the terms “Author” and “Coach” are used interchangeably unless expressly noted otherwise, a person of skill in the art will appreciate that an Author, in some cases, can be one that generated vDML/vDialogs, while a Coach is one that, by manual invention during execution of a vDialog, can result in its modification as described herein.

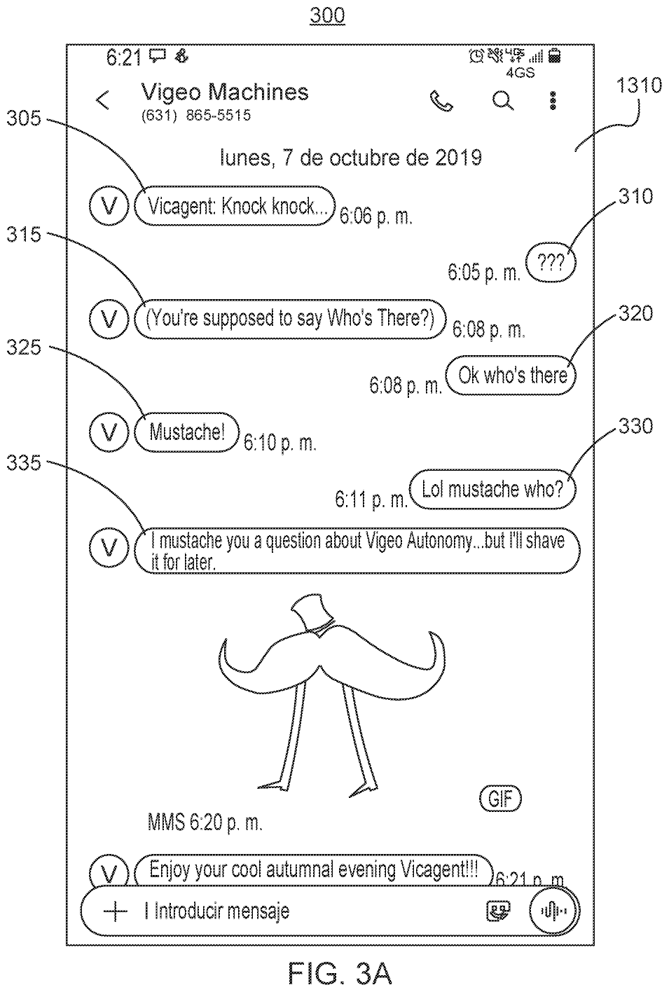

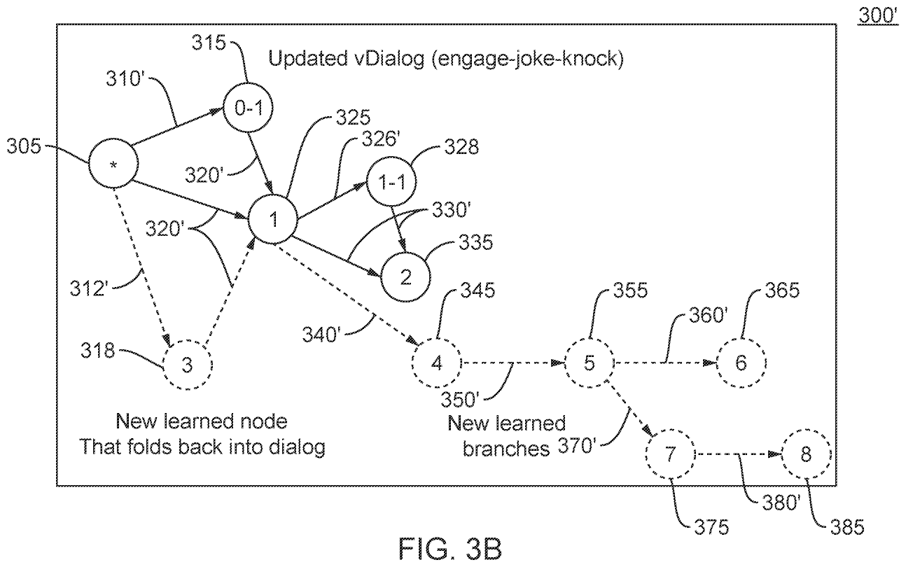

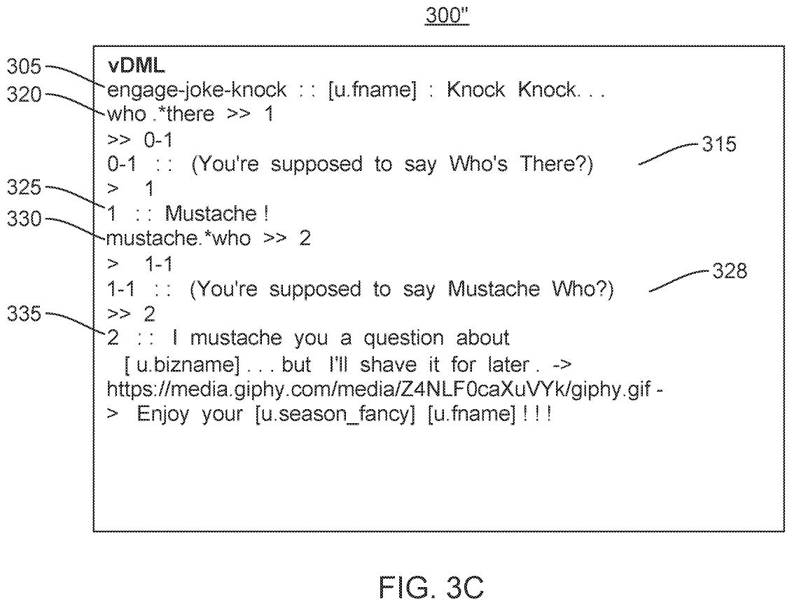

The CPortal 1500 provides an interface for the CAgents 1410 to carry out various vJourney, including vDialog, —based activities including, but not limited to: specifying, writing, and/or otherwise building vDialogs, marking a vDialog as active or inactive, exchanging messages/content with the user device 1300, receiving and responding to dialog-intervention notifications from the server 1100, and/or the like. Generally, the CPortal 1500 can permit for the CAgents 1410 to not only regulate the set of vDialogs 1150 (add, edit, delete, etc.), but also grow then in real-time via manual user interactions. Through either approach, the CAgents 1410 can modify (referring to the graph structure of vDialogs; explained in more detail in FIGS. 3A-3C) vDialogs by pruning/eliminating little-traversed branches, removing little used nodes, merging branches, etc. In some cases, the server 1100 can maintain, and the CPortal 1500 can provide to the CAgents 1410, an up to date queue or listing of self-grown vDialogs which have not been modified or ‘groomed’ by a CAgent. In this manner, aspects of the systems, devices, and methods provided herein permit for automatic vDialog growth that can nevertheless be manipulated and optimized by the CAgents.

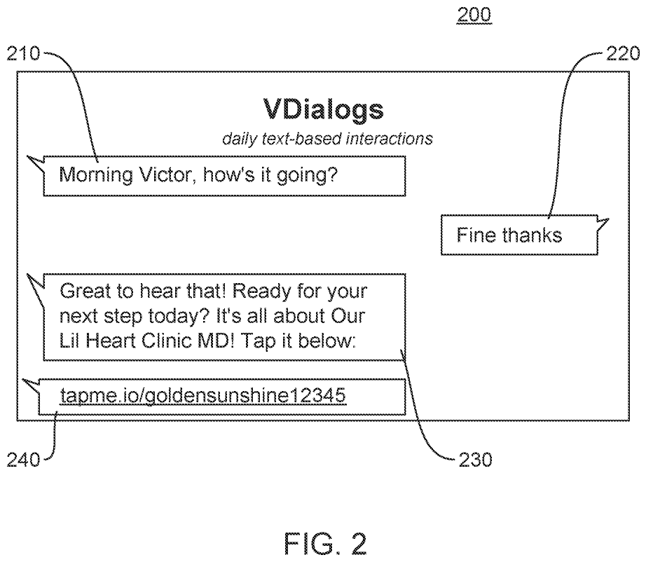

FIG. 2 illustrates an example, text message-based dialog 200 (e.g., corresponding to the vDialog 1150) between a user of the user device 1300 (e.g., via the text app 1310 and the platform server 1100). Generally, it is understood that the term dialog can, unless expressly noted otherwise, refer to a vDialog 1150, the graph representation of the dialog (see FIG. 3B), and/or the vDML representation of the dialog (see FIG. 3C).

Here, the purpose of the dialog 200 is to prompt the user—in this case, an owner of a small business named ‘Our Lil Heart Clinic MD’ who has taken out working capital from a business lender—to proceed along her vJourney. The dialog 200 is initiated by the server 1100 with an informal greeting 210 (“Morning Victor, how's it going?”). The user provides a response text message 220 (“Fine thanks”). Generally a user can respond in a widely varied way to indicate, for example, whether they are feeling well, if they are feeling just okay, if things are not going well, etc. As explained in greater detail herein, if the vDialog 1150 is programmed such that the user's response is recognizable among a list of possible responses (e.g., using string-pattern or semantic analysis), then the jEngine 1110, which is running the vDialog 1150, is able to respond to the user at 230 (“Great to hear that . . . ”) without intervention from the CAgent 1410. The jEngine 1110 can then provide a link to open the next module along the user's vJourney 240.

If the user's response is not recognizable, then the jEngine 1110 can flag the conversation for manual intervention—which then assigns the user's response/dialog to a Coach to handle. In turn, the Coach can provide for the response 230 message back to the user via the Coach device 1400. In some cases, the Coach can also specify one of the pre-existing branches of the vDialog 1150 down which the conversation should flow (explained in more detail in FIG. 3B), and instruct jEngine 1110 to continue vDialog execution, which then yields the response 230 as a programmed response. The Coach device 1400 can further specify whether the Coach device 1400 will retain control of the dialog 200 (i.e., the CAgent 1410 will continue to review and respond to the user), or whether it can be handed back to the jEngine 1110 to continue execution of the vDialog 1500. The user is abstracted from this analysis, and either way, receives either a programmed, human-like response or an actual human response at 230. Accordingly, either the Coach device 1400 or the jEngine 1110 can provide the link 240 to, for example, open the next module or dialog along the user's vJourney as explained for FIG. 5.

Dialogs—Directed Graph and vDML Representation

Having described an example dialog 200, described next is FIGS. 3A-3C are how dialogs can be specified, as well as modified based on Coach-user interactions for subsequent user interactions. While illustrated and explained with references to text message-based dialogs, it is generally understood that any kind of content can be exchanged during a dialog with a user/user device including, but not limited to, text, images, animated images, audio, video, web links, or links to open an app on the user's device. In some cases, the jEngine 1110 can resolve any or all non-textual content (i.e., images, videos, and/or the like) to be sent to the user to a web location accessible via a uniform resource locator (URL), where the URL can then be generated and sent to the user at message dispatch time. The URL can be presented and/or repackaged depending on the destination application such as, for example, in a separate JavaScript Object Notation (JSON) field from a remainder of the text message.

FIG. 3A illustrates a dialog-based interaction 300 of a ‘knock-knock’ joke between the server 1100 (e.g., as carried out by the jEngine 1110) and the user device 1300 such as, for example, via the text app 1310 of the user device. The dialog 300 starts with a message/content 305 with the standard “knock-knock” opening. The user responds with a message 310 “???”, as opposed to the more usual “who's there”. The server 1110 responds to this ‘incorrect’ response from the user with another message 315 stating “you're supposed to say Who's There?”. The user in this example responds with a message 320 “ok who's there”. With this proper response received, the server 1110 responds with the message 325 “Moustache!”. The user now properly responds with a message 330 “lol moustache who?”. The server 1110 then responds with the message 335 “I mustache you . . . ”, which includes an image.

FIG. 3B illustrates a graph representation of the dialog 300, and more specifically, an example directed graph 300′ corresponding to the dialog 300. A directed graph is generally represented by a set of vertices/nodes/points connected by uni- or bi-directional edges, and the graph 300′ accordingly includes as nodes 305, 315, 325, 335 that correspond to the messages of the same reference characters illustrated in FIG. 3A. The graph 300′ also illustrates edges 310′, 320′, 330′ reflecting transitions between the nodes, and that correspond to the messages 310, 320, 330. Generally, when two nodes are connected via a directed edge, the node from which the directed edge proceeds can be considered an origin node, while the node to which the directed edge terminates can be considered a destination node.

The graph 300′ is illustrated as a simple, directed, acyclic graph, i.e., having no loops or cycles, though it is understood that the graph 300′ may take any suitable form depending on the desired dialog-based interaction. For example, the graph 300′ can be or include a symmetric directed graph, tournament graph, complete directed graph, combinations thereof, and/or the like. As another example, the graph 300′ can be or include a weighted directed graph (i.e., with weights assigned to one or more edges), rooted directed graph, signa-flow graph, flow graph, stage diagram, commutative diagram, combinations thereof, and/or the like. The graph 300′ can include any suitable topological elements of directed graphs including, but not limited to, cyclical pathways, forks, merges, and/or the like.

As noted, the edges/transitions 310′, 320′, 330′ of the graph 300′ can be based on the user responses. Whether a user response maps to one of the edges of the graph 300′ can be evaluated in any suitable manner. For example, again assuming that the dialog is text based, the user's text response can be evaluated using any suitable textual analysis technique such as, for example, word frequency analysis, collocation, concordance, text classification (e.g., using sentiment analysis, topic analysis, intent detection, and/or the like, text extraction (e.g., keyword extraction, named entity recognition, and/or the like), word sense disambiguation, clustering, and/or the like.

FIG. 3B illustrates the first message 305 “knock-knock” to the user as an origin node 305. If the user properly responds with “who's there” as determined by textual analysis carried out by the JEngine 1110, this corresponds to the edges/transitions 320′ to the node 325, at which point the message 325 “Moustache!” corresponding to the node 325 is presented to the user.

If the user does not respond in this manner, this corresponds to the edge/transition 310′, at which point the message 315 “you're supposed to . . . ” corresponding to the node 315, is presented to the user. Once the user properly respond to the message 315, the edge/transition 320′ between nodes 315, 325 returns the dialog flow back to the node 325.

Once the message 325 is presented to the user, a proper response as illustrated (i.e., the message 330) corresponds to the edge/transition 330′ between the nodes 325, 335, at which point the message 335, corresponding to the node 315, is presented to the user via the text app 1310. If the user does not provide a desired response (not shown in FIG. 3A), then this corresponds to the edge/transition 326′ between the nodes 325, 328. The node 328 can correspond to a message “You're supposed to say Mustache Who?” to be presented to the user. When the user then properly responds, the edge/transition 330′ between nodes 328, 335 returns the dialog flow back to the node 335.

FIG. 3C illustrates an example vDML code 330″ that can be complied by the jBuilder 1120, and then run by the jEngine 1110, to execute the dialog 300 with the user device 1300. Line 305 corresponds to the node 305, and to the display of the message 305 to the user. Line 320 is a wildcard analysis of the user's response 320, which if proper, results in a jump to line 325 in the code. If improper, the next line 315 is executed, which corresponds to the node 315 and the message 315 presented to the user. Once the execution reaches line 325 (which corresponds to the node 325), it is executed to present the message 325 to the user. Line 330 is again a wildcard analysis of the user's response 330, which if proper, results in a jump to line 335 in the code. If improper, the next line 328 is executed, which corresponds to the node 328, and its corresponding message is presented to the user. Either way, when execution reaches line 335 (which corresponds to the node 335), it is executed to present the message 335 to the user.

Referring again to FIG. 3B, also illustrated in the graph 300′ are how manual interventions by the CAgent 1410 can be employed to grow, change, and/or otherwise modify the graph 300′ and by association, its corresponding vDialog 1150, and the corresponding dialog experience by an end-user. For example, say that, in response to the message 305, the user responds with “I don't understand” or some textual/semantic equivalent thereof, indicating that they are unfamiliar with the question, and likely indicating that they are no familiar with ‘knock-knock’ jokes at all. If so, the vDialog can be programmed that such responses correspond to an edge/transition 312′ that invokes intervention from the CAgent 1410. For example, a notification can be sent by the server 1100 to the CAgent 1410 with information about the vDialog 1150 being executed, the current state of the dialog with the user device 1310 (e.g., the dialog conducted so far), the options for the CAgent 1410 (e.g., to reply to the user's message, to specify a pre-existing branch that the vDialog should step into, to terminate the vDialog, and/or the like) and/or any other information required, desired, or useful for the CAgent 1410 to intervene. In some cases, the information presented to the CAgent 1410 can be specified as a JSON object that includes fields specifying what information regarding the intervention should be packaged and sent to the CAgent 1410.

As illustrated in FIG. 3B, the CAgent 1410 can the provide a manual response/text message to the user explaining how ‘knock-knock’ jokes work, which can establish a new node 318 in the graph 300″. The CAgent 1410 can further specify that control should then return to the node 325. For example, the CAgent 1410 can explain, in the response/node 318, how ‘knock-knock’ jokes work, that the user should now say ‘who's there’, and then specify that, when the user does so, control should return to the node 325. This then establishes the edge 320′ between the nodes 318, 325.

In some cases, the CAgent 1410 can specify that this new node 318 should be made a permanent feature of the graph 300′. For example, if the CAgent 1410 frequently intervenes in a similar manner across multiple users, this can allow them to update the graph 300′ such that, for subsequent users that engage with the updated graph 300′, the response at node 318, a human generated response, is readily available without the need for repeated intervention by the CAgent 1410. In other cases, the CAgent 1410 may deem that the scenario in which the intervention was required (and the node 318 was generated) was so rare/unique that it is not worthy of updating the graph 300′. In such cases, even though the CAgent 1410 properly responds to the user and returns control to the node 325, no changes are made to the graph 300′

In yet other cases, the server 1110 (e.g., the jBuilder 1120) can mine the interventions made by a CAgent 1410 for a particular dialog/graph to determine whether to update that graph 300′. For example, if it is determined that the CAgent 1410 intervenes in the same manner (that results in generation of the node 318) once every thousand executions of the vDialog 1150, the graph 300′ should be updated to incorporate the node 318 and its connected edges.

As illustrated in FIG. 3B, the new node 318 is one that ‘folds’ back, or returns control, to the original/automated dialog flow. As also illustrated in FIG. 3B, it is also possible for the manual intervention of the CAgent 1410 to result in a whole new dialog with the user, and in a whole new ‘branch’ of the graph 300′.

For example, consider that, after the message 325 “Mustache!” is presented to the user, the user responds with the message “Sorry I still don't understand” or some textual/semantic equivalent thereof, indicating that they are still confused, at which point the humor in the moment is likely lost, and there is little gained from continuing with the vDialog 1150 as planned. If so, the vDialog can be programmed that such responses correspond to an edge/transition 340′ that invokes intervention from the CAgent 1410, and/or transitions into another vDialog via a ‘transitioner vDialog’, which is explained in more detail later. The CAgent 1410 can manually respond as they desire such as, for example, parlaying the opportunity that the user's attention is held into a more valuable dialog (e.g., renewing the loan). The subsequent human dialog between the CAgent 1410 and the user of the user device 1300 can be sequentially captured in the illustrated example at nodes 345, 355, 365 and the intervening edges/transitions 350′, 360′. As described earlier, these additional nodes and edges can be made permanent, and can be further ‘grown’ by the addition of nodes 375, 385 and edges 370′, 380′ over subsequent interactions with users.

Described for FIGS. 3A-3C is invocation of manual intervention from the CAgent 1410. Generally, a vDialog can transfer control/flow and/or invoke manual intervention by the CAgent 1410 in at least the following scenarios. First, when the vDialog is expressly programmed to do so. Second, when the user response cannot be mapped to a subsequent branch of 325, and a new branch (e.g., the branch 340′) must be grown. Third, when the dialog flow lands at a terminal or ‘leaf’ node, e.g., the node 335, 365, and/or 385, where there are no additional possibilities for dialog flow and where that leaf node isn't designated to be an end/terminal node that results in completion of dialog flow. Fourth, when the vDialog terminates or times out.

Also described for FIGS. 3A-3C is how a vDialog can be ‘grown’ based on Coach-user interactions for use with subsequent users. In some cases, the growth of a vDialog can be programmatically constrained. For example, a vDialog can be programmed such that (automatically) no additional branching occurs from leaf nodes (e.g., by designating it a terminal node, with vDML notation ‘##’). As another example, the CAgent 1410 and/or other entity can specify that a particular executing vDialog does not ‘learn’ from its current usage, i.e., is not modified based on the CAgent's current intervention. More generally, a vDialog can be set, programmed, or by default, grow/learn/add new nodes and branches based on Coach-user interactions. In some cases, the CAgent 1410 can specify that a particular vDialog, or a particular instance of that vDialog (i.e., during a specific user/user type interacting with that vDialog) be in a ‘no-learn’ mode, such that Coach-user interactions will not result in growth of the vDialog. In some cases, all vDialogs of the server 1100 can be set to such a no-learn mode during a system-wide operation such as, for example, a comprehensive review and editing of the vDialogs 1150 by an Author, Coach, and/or other entity.

In this manner, aspects disclosed herein are useful for exploiting actual human-human interactions (i.e., Coach-user interactions) to modify machine-user interactions for subsequent users, and can result in scalable, highly complex, intricate, evolving, yet human-like, dialogs that maintain user engagement while avoiding redundant input from human Coaches. Example uses of vDialogs can include 1) purposes of generating user engagement—e.g., by delivering jokes to users as illustrated in FIGS. 3A-3C, conducting a pop quiz, dialog-based mini-games, articles, videos—2) the creation and harvesting of new sales opportunities—e.g., harvesting interest in loan, lease, or insurance renewals, harvesting interest in additional financial products, business services, and other targeted sales opportunities—3) to administer in journey teams (e.g., akin to a dialog-based group chat between a team that includes users and/or Coaches on the same vJourney), and/or the like.

vDML Specifications

Generally, vDML or vDialog Markup Language, can be employed for authoring vDialogs, such as the vDialog 1150. FIG. 3C is an example of a vDML for authoring the ‘knock-knock’ dialog described herein, and illustrates several elements/symbols usable with vDML, some of which are:

::—for naming vDialogs, and for naming of nodes within vDialogs. Naming of nodes and vDialogs can permit for arbitrary branching into that node/vDialog. An unnamed node/vDialog can be limited to being branched into by a preceding node/vDialog.

->—for segment breaks (e.g., to step into another node or vDialog), and for sending a message as separate messages.

=>—for evaluating the user's reply/response for patterns, for matching on preceding string, and for delivering subsequent string. For example, matching can be done symbolically (e.g., using regular expression or regex matching), or semantically using various ML libraries such as nitk/gensim running over word corpora from Google®, Twitter®, and/or the like.

<! !> or «»—code pattern, execute enclosed string as script. This can be limited by whitelisted functions, and can generally allow a vDialog to execute any arbitrary script and/or function available on the Platform.

[ ]—vSnippet name (see '501 application), compile the vSnippet into a flat string at dispatch.

{ }—vModule name (see '501 application), compile into a VRL (vModule Resource Locator) at dispatch.

##—if appears at the end of a node, terminates a vDialog with the reason ‘autocapped’.

$$—specifies the properties of a node. For example, $$ expires [N]=>—pipes node to another node upon passage of N minutes without a reply. As another example, $$ autonudge embeds an autonudge into the node.

vDML can also include a specification of line patterns, such as:

[TEXT]—an unnamed Node, generally useless unless it is the Root Node.

[NAME]:: [TEXT]—identifies and names a Node in the vDialog as [NAME] with [TEXT].

[PATTERN]=>[PREDICATE]-[PATTERN] is a response pattern to the previous Node, [PREDICATE] is what action to take next.

=>[PREDICATE]—default action to previous Node, if no response pattern matched.

[TEXT]=>[NAME]—store the [TEXT] response into a [NAME] in the Dialog Context or into the User Datamodel.

vDML can also include a specification of predicate patterns, such as:

[N]—sends the message associated with the named Node.

[TEXT]—sends the specified text.

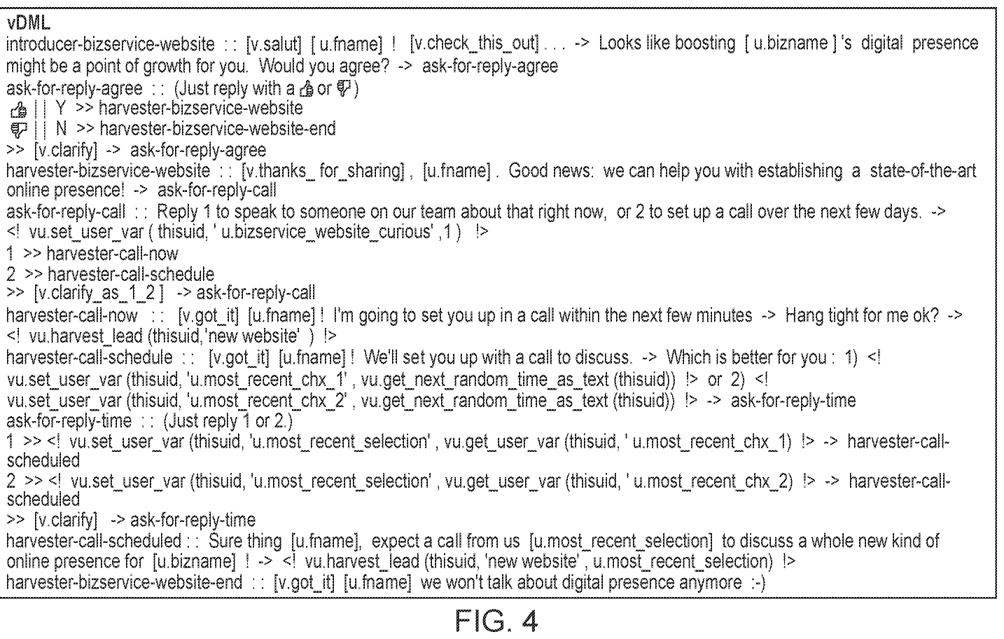

FIG. 4 illustrates a relatively more complex vDML/vDialog specification that solicits a user for a website upgrade.

Yet another example vDML specification for a vDialog that asks the user how their day is, is provided below.

Hey [fname], how's it going?
good >> 1
bad >> 2
>> 1
1 :: [v.great_to_hear] [fname]. −> 1.1
1.1 :: Wanna work on your next step today? −> Gimme a [symbol] to
get started! [symbol]
>> 10
>> 11
10 :: [v.awesome ] [fname] ! [v.tap_link] −> [next_step_vrl]
11 :: Sorry [fname] didn’t get that... −> 1.1
2 :: [v.sorry] [fname] ! −> What's wrong?
work >> 20
sad > > 21
family >> 22
20 :: Sorry to hear about work, [frame] ... −> 20.1
21 :: Sorry to hear you're down, [fname] ... −> 20.1
22 :: Family issues always a bummer [fname] :− ( −> 20.1
20.1 :: Let me know if there's anything I can do to help
>> You're welcome, [fname] ! −> 1.1

Yet another example vDML specification for a vDialog that enrolls a user is provided below.

enroller-nbj :: Hey there [u.fname] ! −> I'm j.coach], with
[p.sponsor], who funded [u.bizname] . −> I was lucky enough to
be paired up to be your Dedicated Business Sidekick [symbol] −> Ever
worked with a biz coach before?<< vu.set_msg_autonudge ( ) >>
no.*interest.* => NO-INTEREST
y || yes => YES-TO-INTRO
n || no || nope || not || never || busy => NO-TO-INTRO
meet || how || cool || hi || hello => MEET-TO-INTRO
call => CALL-MANUAL
who => WHO
talk => OTHER
$$ expires 1400 => << vu.start_vdialog(thisuser, ‘enroller-nbj-
try2’) >>
YES-TO-INTRO :: That's great [v.sal], good that you've got
some prior experience with this. −> INTRO
NO-TO-INTRO :: [v.no_problem] [u.fname] −> INTRO
MEET-TO-INTRO :: Nice to meet you too [v.sal] ! Check this out:
−> INTRO
WHO :: I'm sorry to have confused you some [u.fname] −> I am
with [p.sponsor], the guys you recently took out financing
from: $ [l.fundbal] from [l.funder], −> Ring a bell?<<
vu.set_msg_autonudge ( ) >>
=> WHO-2
WHO-2 :: Glad we came to an understanding ! −> Now check this
out: As part of your financing, you are paired up with a Fun,
Free, Dedicated business coach [symbol] (that's me) −> Ever worked
with a biz coach before?<< vu.set_msg_autonudge ( ) >>
=> INTRO
INTRO :: I'd love to show you how it works and what we'll work
on together. −> It's actually pretty cool, and I promise like
nothing you've ever worked with before :−) Would you like me
to: −> 1) [symbol] you and explain how it works −> or 2) Send you a [symbol]
to open up a 3-minute intro, then tell me if it's right for
you?<< vu.set_msg_autonudge(‘1’ , ‘2’ ) >>
1 || call => CALL-MANUAL
2 || send || link || later || thanks || ty => VRL
n || no || not => TRY
VRL :: [v.got_it] [u.fname] − coming right up! −> Just tap on
this link below, check it out, then tell me if it's right for
you? −> {modA1} << vu.set_msg_autonudge ( ) +
vu.terminate_vdialog(thisuser) >>
NO-INTEREST :: [v.got_it] [u.fname] − thanks for letting me
know. Curious: which of these applies? −> 1 ) You just wanna be
left alone to pay back your loan; −> 2) You'll be going with
another lender; −> 3) You don't need any more financing; −> 4)
You'll likely not be able to pay back in full.<<
vu.set_msg_autonudge (‘1’, ‘2’, ‘3’, ‘4’) >>
1 => TRY
=> OPTOUT
TRY :: [v.no_problem] [u.fname] − How about I send you a link
to a 3-minute game that overviews what your Fun and Free
coaching experience would be like with me. Then you tell me if
it's right for you?<< vu.set_msg_autonudge ( ) >>
y || yes || ok || sure => VRL
=> OPTOUT
OPTOUT :: [v.no_problem] [u.fname] − thank you for giving me a
chance. −> Take care << vu.cut_user(thisuser, ‘user opted out’)
+ vu.terminate_vdialog(thisuser) >>
OTHER :: [v.got_it] [u.fname], though I think I'm talking about
something else. −> How about I send you a link to a 3−minute
storyboard that overviews what your Fun and Free coaching
experience would be like?<< vu.set_msg_autonudge ( ) >>
y || yes || ok || sure => VRL
=> OPTOUT
CALL-MANUAL :: Appreciate your reply, [v.sal] − look forward to
connecting with you! Couple times coming right up...<<
vu.terminate_vdialog(thisuser, ‘@coach: please suggest times’)
>>

User Experience Including vModules and vDialogs

Aspects of the system 1100 can provide for a user experience/‘journey’ or vJourney 500, as illustrated in FIG. 5. Briefly, and as described in more detail in the '501 application, the vJourney 500 can generally be characterized as a set of sequential interactions with a user such as, for example, a set of sequential interactions with a consumer (lender) of a bank loan, with the end goal of ensuring the loan is paid off in a timely manner. The vJourney 500 can include any suitable number of vModules 1250a-m and vDialogs 1150a-n. While the vDialogs 1150a-n are useful for dialog-based interactions with the user, the vModules 1250a-m are useful for presenting dynamically changing, ‘polymorphic’ content to the user within a specific sequence of user interactions/tasks that much be completed before the user can exit the vModule and move on to the next vModule or vDialog. As explained in more detail in the '501 application and briefly here, each vModule 1250 includes a specification of sequence of user interactions. The user interactions can include, but are not limited to, presenting new content to the user (e.g., a set of easy-to-read, animated pages that educates a user on the process of repairing her business credit), nudging/reminding the user to take a specific action (e.g., linking a user in real-time to her loan specialist to discuss refinancing options), collecting active and/or passive user input (e.g., asking the user to select among a list of choices that represent their biggest hurdles to growing her business), and/or the like. The pages of a vModule 1250 can include visual and/or other user experience-able components called vPayloads (see '501 application) that are included if (for each vPayload) certain selection logic is specified.

FIG. 5 then illustrates how control during the vJourney 500 can be passed sequentially between the vModules 1250a-m and vDialogs 1150a-n, although the sequential nature is for example purposes. It is understood that depending on user interaction during (say) a given vModule, the next vModule or vDialog to be invoked can selected. Described with respect to a sequential ordering for simplicity, the specification of a vJourney can include a pre-programmed specification of the ordering of the vModules 1250a-m and vDialogs 1150a-n, or can permit for some or complete user selection. In the following example vJourney, a vDialog initiates a vModule named ‘mod12’ by using the { } notation. This vModule can be deployed, and encompass initiation, completion, and follow up. The vModule can then dispatch a subsequent vDialog named ‘work-habits-vd’.

vDialog:
Check out ur step for today: ->{mod12}
vModule (initiation):
Don't be afraid of the blue link [u.fname]!
(completion):
Hey don't forget to finish ur step [u.fname]
(followup):
Thanks for telling me about your work habits [u.fname]! Let's drill down a bit->work-habits-vd

In some cases, the ordering of the vModules 1250a-1250m and vDialogs 1150a-1150n can be based on learned behavior. For example, if a user hasn't responded to a prompt in a vModule 1250a for over a week and the user is known to be responsive to jokes, a vDialog 1150b can be dispatched to deliver a ‘knock-knock’ joke and reengage the user, and then once the vDialog 1150b completes execution, return control to the vModule 1250a. As yet another example, and continuing with the example vJourney explained above, if execution of the {mod12} vModule indicates that the user specified procrastination as a work habit, a mod44 vModule can be dispatched; if the user specified ‘distraction’, a mod44 vModule can be dispatched instead; and if the user specifies any other response, some other vModule or vDialog can be deployed.

The specification of the vJourney 500 can also include timing of dispatch/execution of each or any of the vModules 1250a-1250m and vDialogs 1150a-1150n such as, for example, waiting a day after a user completes a vModule to initiate the next vModule or vDialog, and/or the like. Further, an Author or a Coach, such as the CAgent 1410, can reorder the sequence of the vModules 1250a-m and vDialogs 1150a-n on the fly and in real-time responsive to changing circumstances, user needs, research, and/or the like.

As a non-limiting example, consider that the vJourney 500 includes 1) a first vModule where the user gets to pick the frequency of messages received at the user device 1300 (e.g., a lot, sometimes, or rarely), and whether they would like to receive messages on weekends (e.g., Yes or No). In addition, 2) the server 1100 maintains an updated set of user behavior patterns such as the time of day and day of week when the user is most likely to perform certain actions such as, for example, tap a link in a message, to send a message back, to pick up a call, and/or the like. Both (1) and (2) can be combined to time the dispatch/execution of a given vModule and/or vDialog if applicable. In some cases, when user does not perform the solicited behavior (e.g., does not tap a link in a message), the user can be sent a nudge (e.g., via an autonudge vDialog). The timing/repetitiveness of delivery of the autonudge in the event of continued non-response from the user can be gradually stretched. In some cases, if the user is unresponsive for a predetermined amount of time and/or number of nudges, control can be turned over to the Coach device 1400 for manual intervention in the vJourney.

As another example, consider that the vJourney 500 includes a first vModule where the user indicates that they are interested in additional, side-jobs. This can result in a related vModule and/or vDialog being programmed into the beginning of their vJourney.

In this manner, where vModules are useful for empowering users to perform particular tasks towards overall fulfillment of a journey or goal, vDialogs are additionally useful for maintaining user connectivity and engagement between vModules. For example, a vDialog that harvests a user's interest in insurance renewal can be employed to drive the user towards a subsequent vModule to determine which kind of insurance product is best for them. Conversely, a vDialog that executes after a vModule can perform a follow-on function for that vModule such as, for example, a Q&A session on best driving practices to maintain low auto insurance premiums. When used in concert with vModules directed to (for example) student loan interest forgiveness/forbearance, vDialogs can prevent long periods of user inactivity that would impair the user's prospects of forgiveness.

Further, since vDialogs are relatively easily and completely specified by vDML, they can be used to run experimental content quickly that would otherwise entail significant development time if implemented as a vModule.

Dynamic User-Interface Generation for vModules

Described herein, and in more detail in the '501 application, is how user interfaces for the vModules 1250a-1250m can be dynamically generated. Generally, each vModule 1150 includes a set of sequential pages (sometimes referred to as vPages) that are visually presented to the user. The pages within a vModule 1150 can be sequenced in a linear or multi-branching fashion, or combinations thereof. A page can include is a representation of visual elements, similar to a web page, and can be static, interactive, or include combinations thereof. A vPage can include at least one of a vComponent, a vSnippet (vComponents and vSnippets are explained in greater detail below), or some other element. The other element can include any suitable, visually renderable element such as, for example, static text and/or image. A page might by way of example ask the user to identify her perceived obstacles to paying off her loan.

Each vComponent can include one or more user-interactive elements, such as, for example, a list (e.g., select the considerations that build your retirement plan) that the user can select one or more elements from, a text box for user entry, and/or the like. In some cases, a vComponent can consume a vSnippet, as explained below. A vComponent might, by way of example, ask the user to select from among a set of possible reasons that would preclude her from paying off her loan. The set of possible reasons would be encapsulated in a vSnippet, in which each individual reason is a vPayload. Tags and logic may dictate whether certain vPayloads are expressed. For example, users with children might see children-related reasons in the list, whereas users without families will not see these reasons.

Each vSnippet included in the vPage and/or a vComponent includes one of one or more vPayloads (also sometimes referred to as a selected payload) associated with that vSnippet. Each vPayload is an element that can be included in a vPage and/or a vComponent if certain criterion are met. Specifically, each vPayload can include an indication of one or more tags, selection logic (i.e., for selection to be presented to the user), and a weight parameter. A payload can generally be represented as:

vPayloadn→{Tag1, Tag2 . . . }, logic, weight

Each tag and logic associated with a vPayload is used to determine if that vPayload is to be selected for presentation to the user. The weight, which can be defined by any floating point number or similarly dense, well-ordered set of scalars associated with a vPayload, is used to determine the probability, once that payload has been selected for presentation, that that payload is presented to the user by comparing the weights of all selected payloads. Applying random selection to multiple selected payloads to select a single payload for user presentation, based on their respective weight parameters, can result in content polymorphism not only across multiple users but also at different time points in interacting with the same user.

How a vPayload is selected for a given vSnippet can be explained with respect to an example. Suppose the example vSnippet_example includes the following payloads:

vPayload1→{Tag1}, logic=user_male, weight=1

vPayload2→{Tag1, Tag2}, logic=user_female, weight=5

vPayload3→{Tag1}, logic=1, weight=0.5

vPayload4→{Tag10}, logic=1, weight=10

Further, consider the following criterion (e.g., established by the jBuilder 1120) selecting a payload for vSnippet_example—that a) the tag must match “Tag1”, and that b) the logic must match the demographic information that the user is male.

At a first step of payload selection, the criterion logic is compared against the logic for each payload in vSnippet_example. Here, vPayload1, vPayload3, and vPayload4 all match the requirement that the user is male, and vPayload2 is dropped. In this example, vPayload3 and vPayload4 having a logic=1 is assumed to mean that they are always considered to match the criterion logic. Examples for when a vPayload's logic might be set to 1 can include, but is not limited to when 1) a vPayload should be universally available, and 2) when tags alone are sufficient to describe the expressible context of the vPayload.

In a next step, the criterion tag(s) (which can be optional) are compared against the tags for vPayload1, vPayload3, and vPayload4. Here, vPayload1 and vPayload3 both have the requisite “Tag1” while vPayload4 does not, and is dropped.

In a next step, one of vPayload1 and vPayload3 is randomly selected based on their respective weight parameter. Examples of such weighted, random selection can include, but are not limited to, randomized selection after linear mapping of the weight parameters, after exponential mapping, after quadratic mapping, after squaring the weight parameters, and/or the like. Here, vPayload1 has a weight of 1 and vPayload2 has a weight of 0.5, so vPayload1 has a ⅔^{rd} chance of selection, and vPayload2 has a ⅓^{rd} chance of selection as the selected payload for its corresponding vSnippet_example, which is then presented on its corresponding vPage and/or vComponent. The presented aspect of the vPayload can be any suitable entity (sometimes referred to as a payload ‘value’) such as, for example, text, an image, and/or the like.

The weight of any vPayload can be modified over time based on factors such as which vPayload gets the highest level of attention, the correlation between vPayloads, the likelihood and intensity of daily engagement of the user, efficacy of the behavioral techniques being applied to the user, and the user's progress towards overall goal and/or sub-goal attainment. In this manner, aspects disclosed herein are useful for dynamic generation of digital interactive content, and specifically for presenting polymorphic content based on runtime modification of payload weights over time, and in a learned manner.

A simple example of a vSnippet (say, “vSnippet_yes_no”) is one that includes three payloads related to responses a user can provide to a question:

vPayload1→{absolute}, logic=1, weight=1. Value=“yes”

vPayload1→{absolute}, logic=1, weight=1. Value=“no”

vPayload1→{ambiguous}, logic=1, weight=1. Value=“maybe”

Such a vSnippet can be consumed by a vComponent such as to, for example, provide a selectable list (vComponent) of yes/no/maybe (consumed vSnippets) options in response to a question asked of the user in the corresponding vPage.

Another example of vSnippet (say, “vSnippet_skipwork”) can be used to illustrate the various ways that vSnippets can be consumed. vSnippet_skipwork can include the following payloads:

vPayload1→{ }, logic=1, weight=1. Value=“feeling lazy”

vPayload1→{ }, logic=1, weight=1. Value=“not in the mood”

These payloads can be flexibly rendered to the user as part of a selectable list (i.e., as part of a vComponent), or provided as a static list directly in a vPage (i.e., as an embedded vSnippet) as an informative listing of reasons why people typically skip work.

Example vDML for vDialogs

Provided herein are various, non-limiting examples of vDML specifications of vDialogs and their resulting features. With regard to passing control between the vDialog 1150 and the Coach device 1400, as noted herein, one way this occurs is when the vDialog 1150 cannot map a user response to a subsequent branch of its directed graph (e.g., either by string, one-of-list, or semantic analysis), it flags for manual intervention from the Coach device 1400/CAgent 1410.

Another way the vDialog 1150 can pass control to the Coach device 1400 is if the vDialog times out, with no response from user. See example vDML below:

$$ expires 1400=>##

Yet another way the vDialog 1150 can pass control to the Coach device 1400 is if the current node of the vDialog is an ‘end node’, with a ‘##’ specification. See example vDML below:

OPTOUT :: [v.no_problem] [u.fname] − thank you for giving me a
chance. −> Take care << vu.cut_user(‘user opted out’) >> ##

Yet another way the vDialog 1150 can pass control to the Coach device 1400 is if the current node of the vDialog is coded specifically to call for manual intervention. See example vDML below:

CALL-MANUAL :: Got it [u.fname], calling you now... <<
vu.call_mi (‘@coach: please call user’) >>

An example vDML that include a cyclic pathway is presented below:

engage-riddle-bookkeeper :: Ready for a riddle, Comedy Timers ?
−> BODY
BODY :: What English wo rd has three consecutive double
letters? −> Hint: it's a type of hat a biz owner like you
might need to wear for [u.bizname].
bookkeep.* => Ding ding ding! You got it! ##
answer || give up || dunno || don't || pass => The answer
is... −> Bookkeeper! −> Like that riddle [v.sal] ? ##
=> Sorry, try again −> (Give up? Just reply: ANSWER) −> BODY

In this case, the final node of the vDialog returns runtime to a previous node.

Another example vDML for a vDialog that can grow a new node (e.g., the node 318) based on Coach intervention is presented below:

growable-vd :: How are you [u.fname]?
vdml.semantic_match (‘good’) => GOOD
vdml.semantic_match (‘bad’) => BAD
GOOD :: Cool! ##
BAD :: Sux! ##

Assume this results in the following exchange with the user:

Vigeo :: How are you John?
User: Why do u want to know??

The response is not recognized by this vDialog, resulting in intervention by a Coach, who responds with the following message:

Coach: Um cuz I care about you?

The vDialog is updated with this response as follows:

growable-vd :: How are you [u.fname]?
vdml.semantic_match (‘good’) => GOOD
vdml.semantic_match (‘bad’) => BAD
*why do u want to know?? => newnode-a1s2d3f4
GOOD :: Cool! ##
BAD :: Sux! ##
*newnode-a1s2d3f4 :: Um cuz I care about you?

The * specifies the new lines as automatically grown, and flags them for subsequent grooming/editing by an Author, Coach, and/or the like.

Alternatively, consider that the Coach reviews the user response and specifies (vie the cPortal 1500) that this should just map to the ‘BAD’ response option. The vDialog is then updated as follows:

growable-vd :: How are you [u.fname]?
vdml.semantic_match(‘good’) => GOOD
vdml.semantic_match(‘bad’) => BAD
*why do u want to know?? => BAD
GOOD :: Cool! ##
BAD :: Sux! ##

As another example, vDML presented below illustrates how a node can be designated to be terminating, with a ‘##’ string:

END :: I mustache you a question about [u.bizname]...but I'll
shave it for later. ##

As another example, vDML presented below illustrates a nodes that do not have any subsequent branch lines can act as a leaf node:

LEAF :: Now I'm a leaf cuz I don't have any ‘=>’ lines beneath
me
NODE :: I'm not a leaf cuz I got ‘=>’s beneath me, and any
user reply will cause runtime to move to the node named LEAF
=> LEAF

If during a dialog the user gets to NODE in the above example, the dialog will proceed as follows:

<previous conversation>
Vigeo: I'm not a leaf cuz I got ‘=>’s beneath me, and any user
reply will cause runtime to move to the node named LEAF
User: wtf you talking about?
Vigeo: Now I'm a leaf cuz I don't have any ‘=>’-lines beneath
me
<subsequent conversation>

Depending on the last user response, new branches can be grown from the LEAF node in the vDML example above.

Another example vDML presented below illustrates how a named node ‘GOOD’ can be arbitrarily branched into:

hello-vd :: How are u [u.fname]?
vdml.semantic_match(‘good’) => GOOD
=> BAD
GOOD :: Awesome ##
BAD :: Well that's the opposite of... −> GOOD

This can result in the following dialog with the user:

Vigeo: How are u John?
User: Buzz off
Vigeo: Well that's the opposite of...
Vigeo: Awesome

Another example vDML presented below illustrates how segment breaks ‘->’ can be used to branch into another node or vDialog (here, the named vDialog ‘shrink-vd’):

hello-vd :: How are u [u.fname]?
vdml.semantic_match(‘good’) => GOOD
=> BAD
GOOD :: Awesome ##
BAD :: Sounds like we need to talk about this −> shrink-vd

Another example vDML presented below illustrates the use of regular expression (regex) string pattern matching of user responses:

NODE :: Say something [u.fname]
^{\hat{ }}hello* => ...

Another example vDML presented below illustrates the use of list matching of user responses. List matching can also employ semantic matching:

NODE :: Which one [u.fname]?
vdml.list_match(′1’) => ...
vdml.list_match(′2’) => ...
vdml.list_match(′3’) => ...

Another example vDML presented below illustrates the use of semantic matching of user responses:

NODE :: How are u [u.fname]
vdml.semantic_match(‘good’) => ...

Another example vDML presented below illustrates how a vDialog can perform other actions than dialog such as, for example, presenting a calendar to a user to pick a time:

SCHED-AUTO :: Pick a time [u.fname]: <<
vu.pick_cal(thisuser,‘new-r’,n=2,dur=30) >>

This vDML/vDialog generates two time slots of 30 min each according to the ‘new-r’ vEvent template.

Additional example vDMLs presented below illustrates how variables and vSnippets can be flattened into text when dispatched to the user. Consider the following three different greetings in vDML:

NODE :: Hi Dan
NODE :: Hi [u.fname]
NODE :: Hi [v.random_name]

When flattened to send to the user, these respectively become

### Vigeo: Hi Dan

Vigeo: Hi Dan (gets value from the ‘u.fname’ variable in the user datamodel)
Vigeo: Hi Bob (gets value from the ‘v.random name’ pre-packaged vSnippet)

Another example vDML presented below illustrates how vModules can be flattened/compiled into links when dispatched to the user:

NODE :: Here's ur next step [u.fname]->{mod12}

This results in the following dialog with the user:

Vigeo: Here's ur next step Dan
Vigeo: https://tapme.io/happyrhino12345

A user tapping the link above would be directed to the vModule named ‘mod12’ to continue on the user's vJourney.

Another example vDML presented below illustrates an ‘autonudge’ vDialog, which can be invoked upon user non-response, such as within a predetermined time period:

BIZNAME :: What is the name of your business [u.fname]? <<
vu.set_msg_autonudge( ) >>

Per this vDML, the user receives the following message:

Vigeo: What is the name of your business Dan?

Then after no response (for say 3 hours), the autonudge vDialog is invoked, and the user receives the following preset message:

Vigeo: Let me know sir! ;-)

Additional example vDMLs of autonudge vDialogs can be as follows, and ask for a user to pick from an arbitrary list of choices—e.g., a Y/N option, a 1/2/3/4 selection:

vu.set_msg_autonudge(′Y′,′N′)
vu.set_msg_autonudge(′1′,′2’, ‘3’, ‘4’)

Additional Characteristics of vDialogs

The vDialog(s) 1150 can include some features (i.e., that can be programmed via vDML) that aid in their authoring, deployment, and/or use during a vJourney. For example, a vDialog can be assigned a unique ‘name’. a vDialog can invoke other vDialogs as explained above for the vJourney 500, and can also be dispatched/invoked by other components (e.g., vAgents, see the '501 application). The vDialog can also dispatch/invoke other components for purposes such as, for example, to set a variable value based on a response provided by a user. For example, if the user provides the name of their pet in a response during a dialog, the vDialog can invoke the necessary component to store that value in a user-associated variable for later use. In some cases, the vDialog can store replies, or portions thereof, to variables themselves.

A CAgent 1410 can expressly, and without being requested, interrupt a vDialog mid-execution. vDialogs can also include mechanisms to prevent infinite waiting times, in the event the user fails or neglects to respond. For example, a vDialog can execute a timer after sending a message/content to the user, and if the user does not respond within a predetermined time period, take some remedial action such as resend the last message, send a reminder, exit the vDialog, yield control to the CAgent 1410, and/or the like. Further, a user can only interact with one vDialog at a time.

Additionally, the CAgent 1410 can be permitted to (e.g., via the CPortal 1500) implement unnamed vDialogs on the fly/in real time. In this manner, CAgents can initiate and store ‘drafts’ of potential vDialogs for later editing and naming. As an example, consider that the CAgent 1410 wishes to collect ad hoc data on children's names. They can implement and dispatch an unmade vDialog of the form:

Hey [u.fname], got any kids?
vdml.semantic_match(‘yes’) => Great, what are their names? ##
vdml.semantic_match(‘no’) => All good, me neither! ##

They can run the vDialog as long as needed and receive the corresponding responses from users who interact with it. Once execution of the vDialog is complete, it may not be run again unless it is then named.

Further, the activity of vDialogs (e.g., the number of times it is invoked, how often each node and/or edge is traversed, how often CAgents have to or are asked to interrupt its execution, how often a user provides an unexpected response, and/or the like) can be measured and employed for statistical analysis, as input to machine learning approaches, and/or the like.

In some cases, a standardized vDialog, also sometimes referred to as a ‘transitioner vDialog’, can be provided. The transitioner vDialog can be invoked when, for example, a vModule or another vDialog ends execution, and can be employed to transition the user interaction to the next vModule and/or vDialog. For example, consider the following vDialog:

REVISIT-CONFIRM :: [v.got_it] [v.sal], it's a Free Country after
all ;−)<< vu.cull_harvest(thisuser,‘re’,‘going with another
lender’) + vu.set_msg_transition(thisuser,‘step’) >>

This vDialog invokes the ‘vu.set_msg_transition’ vDialog, which is as follows:

“transitioner-step-1”:
{
“_payload”:“[v.in_the_meantime], how about your next step!<<
vu.send_next_step (thisuser) >>”
,},

The resulting dialog with the user can be as follows:

Vigeo: No sweat, sir, it's a Free Country after all ;−)
Vigeo: In other news, how about your next step!
Vigeo: https://tapme.io/happyrhino12345

In summary, aspects disclosed herein can provide user-specific, adaptive dialog content and can interact with the user in a human-like manner. Specifically, human interventions along with machine-learning techniques can be employed to dynamically modify an interactive dialog for a user. Human interventions can be pre-specified by one or more Coaches, learned in real-time from interactions between a User and one or more Coaches engaged in dialog, and/or the like.

The interactive dialog for each user can be structured as a directed graph. The set of nodes in the directed graph can represent content to be rendered to the user. The edges in the directed graph can be directed edges that connect two nodes in the set of nodes. Each edge can represent the possible ways a user response can result in a subsequent step in the dialog.

The interactive dialog can begin with rendering and/or presenting to a user content that is associated with an origin node of the directed graph. In response to this rendered content, the user can respond with a user input. This user input can be parsed to determine if it maps to an edge in the directed graph. If it does not map to any edge in the directed graph, a Coach can intervene and provide a response to this user input. The content of this response by the Coach can be structured as another node which is added to the directed graph. Optionally, an edge can be incorporated to the directed graph such that it connects the origin node to this newly added node. The directed graph can be updated dynamically in this manner.

Now consider rendering the user content associated with the origin node in the directed graph to another, subsequent user. If the user responds with a similar user input as the previous user, when this user input is parsed it maps to the newly added edge in the directed graph. Therefore, in response to this user input for the other user, the content in the newly added node is rendered to the other user without intervention from the Coach. In this manner, an interactive dialog can be dynamically modified.

In one implementation, these multi-branching, dynamically-updated directed graphs can be represented using a vDialog Modeling Language (vDML) as described herein. vDML uses a set of symbols and patterns to define a graph. A programmer can codify the directed graphs using the symbols and patterns in vDML.

Machine Learning Techniques for Use with Dialog-Based Interactive Content

The system 1000, which executes interactive dialogs (e.g., the vDialogs 1150) as described herein over a thousands of users—each pursuing a vJourney, several vJourneys, or not at all—over a period of time (e.g., months, years) can generate corpora that can be readily mined using, for example, natural language processing models, deep learning networks, and/or the like. Examples of such mining approaches include semantic augmentation, traversal-space, and grow space, each explained in more detail in turn below.

In semantic augmentation, every branch of every dialog serves as a semantic anchor-point for the accumulation of semantic affinities, which are described herein. When a vDialog passes control to Coach upon an unmatchable, inbound user message, and the Coach elects to re-route the inbound message to a pre-existing branch (with its match pattern) of the vDialog, the system accumulates a pair of ‘semantic affinity’: i.e., between the unmatched inbound user message and the pre-existing match pattern of the pre-existing branch that the Coach elected. Said in a simpler way, a semantic affinity can be considered the equivalent of ‘when users says X they means Y’. As time goes on, a library of such semantic affinities is accumulated by the system 1100. This library can also be exploited to supplying the system's own semantic matching approaches—e.g., for vdml.list_match ( ) and vdml.semantic_match( ) (see vDML examples above)—with novel semantic data, such that these semantic matching approaches can be/encompass machine learning approaches, and accordingly be trained with these real, topically-focused conversations between real humans. As these semantic matching approaches improve with the availability of increasing number of semantic affinities over time, an exponentially smaller percentage of total message exchanges between users of the user devices and the system 1100 would need human intervention, resulting in better performance and scalability of the system.

The traversal-space of interactive dialogs, such as the vDialogs 1150, can include a listing of users traversing the vDialogs, with each entry in the listing specifying a node and a branch of every dialog that every user has traversed, a timestamp for when the user arrives at that node, how long the user remained on that node, and how many times, if any, there were any re-traversals (e.g., if the user traversed the same node during the same session with a given vDialog due to a circular pathway, the user interacted with the vDialog a second time because a CAgent 1410 deemed it necessary/desirable, and/or the like). This listing/dataset can be mined for an innumerable number of optimizations in the grooming of currently-live interactive dialogs and/or the design of future dialogs. As an example, content creators (sometimes referred to as Authors) building a new interactive dialog can be prompted and/or otherwise be provided, when designing a node, if/when the likelihood of a user ever traversing that node would falls below a certain threshold (e.g., because of the depth of that node in the directed graph representation of that dialog, total character length of the message associated with that node, keywords in a word-bag representation of the message associated with that node, and/or the like) based on information mined from such a listing. As another example, based on information mined from such a listing, Authors can be shown, at every step of creation of a dialog, a list of keywords that should be included at in a given node to boost user engagement by some meaningful level (e.g., to include a specific image, or the word ‘happy’). As yet another example, when Authors create a new node, they can automatically be shown (based on information mined from such a listing) a suggested or recommended list of common, high-engagement branches that semantically similar nodes across all interactive dialogs feature as branches, in turn saving time lost to re-creativity (e.g., branches should include options like ‘a lot’, ‘sometimes’, and ‘a little’). As yet another example, the system 1100 can automatically replace specific keywords or key-phrases in the messages/content of nodes with their more engaging versions (i.e., determined to be more engaging based on information mined from such a listing) across manually selected, automatically selected, or all interactive dialogs (e.g., switch ‘happy’ with its vSnippet ‘[v.happy]’). As yet another example, based on information mined from such a listing, the system 1100 can automatically groom interactive dialogs in which one textual formulation within a semantically affine set of formulations (learned via semantic augmentation, above) gets meaningfully higher engagement (e.g., all dialogs should ask users to reply with ‘Y’ or ‘N’ instead of ‘Yes’ or ‘No’). Such automatic optimizations can add up over time into drastic performance improvements of the system 1100, and an improvement in experiences for the user.

The grow-space of interactive dialogs can include/be characterized as the subset of nodes and branches of any given dialog that are learned from observing real-world human-to-human (i.e., Coach-user) interactions within existing, interactive dialog structure. This grow-space immediately lends itself as a data bed over which interactive dialogs can learn from each other in growing new nodes and branches. For example, assume there are 100 instances across all interactive dialogs in which a user is expected to reply ‘good’ or ‘bad’ to a question about how they are feeling. Now consider that, during the execution of one such dialog, a user replies with a ‘so so’, which results in Coach-intervention, who then replies with ‘Hey that's life’, resulting in a new branch in that dialog. Then, all 100 instances, across the multiple dialogs, will grow that branch as well. The semantic matching employed to lasso together the 100 instances cane done in any suitable manner including semantic augmentation. In a sense, with enough deep branches grown, the grow-space can then be used to ‘fill itself up’, all with standard natural language processing techniques. As an example, consider that a deep branch can be one grown from a base node by a vDialog due to a long conversation between the user and the Coach. These deep branches can be added to and/or otherwise picked up (i.e., used to fill up) by more shallow vDialogs that have a node semantically matching the base node.

In summary of these example approaches, a set of labeled semantic affinities between novel inbound user messages and existing match patterns can be used to enhance semantic prediction over all NLP-driven aspects of the system, including semantic analysis employed in vDialogs (i.e., semantic augmentation). The traversal-space (i.e., which users went how many times down which branches) principally informs the subsequent design of interactive dialogs across all populations and journeys on the system 1000. The grow-space (i.e., the growing body of human-to-human messages and the contexts in which they likely appear) can be mined for generalized learning, where all nodes of a class across all dialogs automatically pick up the new branch that one of its members has acquired manually.

Just as the three datasets above—list of semantic affinities, the traversal-space, and the grow-space of vDialogs—can be said to be the data bed over which interactive dialogs can be made better versions of themselves, the full exchange of messages—whether automated or manual—between the system and its users is the data bed over which new interactive dialogs are born—through the detection of repeat patterns which are not already mediated by an interactive dialog. As the total coverage of interactive dialogs approaches unity—i.e., as the messages which are mediated by interactive dialogs (and do not require manual intervention) approaches 100% of all messages—the journey becomes essentially ‘autonomous’ and costs of running it collapse.

Accordingly, in some aspects, methods for dynamic modification of dialog-based interactive content (e.g., the vDialog 1150) associated with a set of target users (e.g., users of the system 1000, such as a user of the user device 1300), the dynamic modification being responsive to user input from one or more target users of the set of target users, include receiving the specification of the interactive dialog (e.g., a serialized specification, such as the vDML specification described herein) for the set of target users, the interactive dialog structured as a directed graph (e.g., see FIG. 3B). The directed graph includes a set of nodes (e.g., the pre-authored/pre-specified nodes of the graph 300′), wherein each node represents content (e.g., a text message, image, and/or the like) to be rendered to that target user via a display device of that target user. The directed graph also includes a set of edges (e.g., the pre-authored/pre-specified edges of the graph 300′), each edge of the set of edges being a directed edge (e.g, the edge 320′) connecting two nodes (e.g., the nodes 305, 325) of the set of nodes, wherein each edge represents an anticipated user response of that target user to the content associated with an origin node (e.g., the node 305) of the two nodes. The content associated with each node of the set of nodes can independently include one or more of a text message, an image, an animated image, a video, and/or a hyperlink.

The method further includes transmitting, for rendering, to a first target user of the set of target users via a first user device associated with the first target user, content associated with a first node (e.g., a message associated with the node 305) of the set of nodes, the first node being an origin node for one or more first edges of the set of edges. The method also includes receiving, responsive to the rendering of the content associated with the first node at the first user device, a first user input from the first target user via the first user device. The method further includes parsing (e.g., via regex analysis, semantic analysis, and/or the like) the first user input to identify whether the first user input maps to any edge of the one or more first edges, and when the first user input does not map to any edge of the one or more first edges (i.e., when the user's response does not match any of the edges), communicating an indication of the content associated with the first node and the first user input to an author device (e.g., the Coach device 1400) of the author user (e.g., the CAgent 1410). In some cases, the parsing the first user input is based on one or more of 1) linear string comparison, 2) regular expression matched comparison, 3) semantic distance, or 4) intention map.

The method also includes receiving, from the author user, via the author device, and responsive to the communicating, a specification of an update to the directed graph. The specification of the update includes a specification of a second node (e.g., the node 318, the node 345, and/or the like) to be incorporated into the set of nodes, the second node representing content (e.g., the response provided by the CAgent 1410 to the user device 1300) to be rendered to the first user responsive to the first user input. The specification of the update also includes a specification of a second edge (e.g., the edge 312′) to be incorporated into the set of edges, wherein the first node (e.g., the node 305) is an origin node for the second edge and wherein the second node (e.g., the node 318) is a destination node of the set of edges, the second edge representing the first user input. The method further includes updating the directed graph based on the update received from the author user (e.g., updating the vDialog 1150 to include the node 318 and the edge 312′, to include the node 345 and the edge 340′, and/or the like). The method further includes transmitting, for rendering, to the first target user via the first target device and responsive to the first user input, content associated with the second node (i.e., providing the CAgent's 1410 manual response to the user device 1300).

In some cases, the method can further include transmitting, for rendering, to a second target user of the set of target users via a second user device (e.g., another user device associated with a second user of the server 1100) associated with the second target user, content associated with the first node of the set of nodes. The method can also include receiving, responsive to the rendering of the content associated with the first node, a second user input from the second target user via the second user device. The method can also include parsing the second user input to identify whether the second user input maps to any edge of the one or more first edges or to the second edge. The method can also include when the second user input maps to the second edge (e.g., to the newly incorporated edge 312′), transmitting for rendering, to the second target user via the second user device and without any input from the author user (i.e., without any manual intervention from the CAgent 1410 again), the content associated with the second node.

In some cases, the specification of the update to the directed graph further includes a specification of a third edge (e.g, the edge 320′ connecting the nodes 318, 325) to be incorporated into the set of edges, wherein the second node is an origin node for the third edge and wherein a third node (in this example, the node 325) of the set of edges is a destination node for the third edge.

Now consider the growth of the branch of the graph 300′, starting with edge 340′. In some cases, the update is a first update (e.g., that results in generation of the edge 340′ and the node 345), and the method can further include receiving, from the first user device, responsive to the rendering of the content associated with the second node, another (e.g., a third) user input from the first target user. The method can further include transmitting an indication of the third user input to the author device of the author user (i.e., request manual intervention of the CAgent 1410). The method can further include receiving, from the author user via the author device, a specification of a second update to the directed graph, The second update can include a specification of a fourth node (e.g, the node 355) to be incorporated into the set of nodes, the fourth node representing content to be rendered to the first user responsive to the third user input (e.g., the content can be a manual response of the CAgent 1410 to the third user input). The second update can also include a specification of a fourth edge (e.g., the edge 350′) to be incorporated into the set of edges, wherein the second node (e.g, the node 345) is an origin node for the second edge and wherein the fourth node (e.g., the node 355) is a destination node of the set of edges, the fourth edge representing the third user input. optionally, a specification of a fifth edge (e.g., the CAgent 1410 can specify an edge to connect the node 355 back to another node within the graph 300′; not illustrated) to be incorporated into the set of edges, wherein the fourth node is an origin node for the fifth edge and wherein a sixth node of the set of edges is a destination node for the fifth edge. The method can also include updating the directed graph based on the second update received from the author user (i.e., updating the graph 300′ to incorporate the node 355 and the edge 350′), and rendering, to the first target user via the first user device and responsive to the second user input, content associated with the fourth node (i.e., the CAgent's response to the third user input, now associated with the node 355).

In some cases, the dialog (e.g., the vDialog 1150a) is a first dialog of a set of dialogs (e.g., the dialogs 1150a . . . 1150m), further comprising executing each dialog of the set of dialogs based on a predetermined order associated with the first user such as, for example, the order specified in the vJourney 500 specific to a given user or group of users. In some cases, the order further specifies an order of execution for each module of a set of modules (e.g., the set of vModules 1250a . . . 1250n), each module of the set of modules including a user interface for display to the first user. In some cases, the order of execution (e.g., for the vModules and vDialogs in the vJourney 500) can be modified based on the first user input, e.g., a user response indicating that they are interested in a side-job can result in a reshuffling that puts a side-job vDialog next in queue to be dispatched to the user. In some cases, the order of execution can includes timing information for execution of each dialog of the set of dialogs and for execution of each module of the set of modules, e.g., the specification of the vJourney 500 can indicate day of week and/or time of day information for the vDialogs 1150a . . . 1150n and the vModules 1250a . . . 1250m. In some cases, the timing information can be modified based on the first user input such as, for example, modifying delivery of a vDialog based on user input that they prefer not to receive messages on a weekend.

In some cases, the user interface (to be presented to a user via their user device 1300, such as via the vApp 1320) for at least one of the modules can be dynamically generated as follows. A first specification of a user interface element to be rendered on that user interface can be received, such as at the JBuilder 1120. The specification of the user interface element includes one or more first user interface keywords (e.g., a keyword ‘Tag’′, such that the payload must match this keyword), wherein the set of modules is associated with one or more user parameters of the first user. For instance, a vJourney can be specifically designed to a male user. In such a scenario, the user parameter would be male gender. A first set of payload elements can be identified as associated with the user interface element and deemed selectable for rendering as the user interface element on that user interface. Each payload element can include a specification of one or more payload keywords (e.g., ‘Tag1’, ‘Tag2”, etc.), selection logic 9 e.g., logic=1, logic=user_male, logic=user_female, etc.), and a payload weight (e.g., weight=0.1, 1, 5, 10, etc.). The first set of payload elements can be filtered based on comparing the one or more payload keywords of each payload element of the first set of payload elements against the one or more user interface keywords to generate a second set of payload elements (e.g., to select payload elements that match “Tag1”). Then, the second set of payload elements can be filtered based on comparing the selection logic of each payload element of the second set of payload elements against the one or more user parameters to generate a third set of payload elements (e.g., select payload elements where logic=user_male to match the ‘male gender’ user parameter example above). Then a first payload element can be selected, via weighted random selection, from the third set of payload elements based on the payload weight of each payload element of the third set of payload elements. That user interface can be rendered on the display of the display device (e.g., on the user device 1300, via the vApp 1320) with the selected first payload element as the user interface element.

In some cases, the CAgent 1410 can make further updates to the graph 300′, sometimes also referred to herein as trimming, grooming, and/or the like. Accordingly, in some cases, the update can be a first update, and the method can include receiving, from the author user via the author device, a specification of a second update to the directed graph. The second update can include one or more of a specification of one or more nodes to be removed from the set of nodes (e.g., to remove the node 318, or the node 315), a specification of one or more edges to be removed from the set of edges, or a specification of two or more edges of the set of edges to be merged. The method can then further include updating the directed graph based on this second update.

As described herein, a node can be expressly programmed for manual intervention by the CAgent 1410. Accordingly, in some cases, at least one node of the set of nodes can include an indication to communicate the content associated with that at least one node to the author device of the author user (i.e., coded for manual intervention, such as by calling vu.call_mi as described in the vDML examples above), and the method can further include communicating the content associated with that at least one node to the author device of the author user.

In some aspects, systems for dynamic modification of dialog-based interactive content (e.g., the vDialog 1150) associated with a set of target users (e.g., users of the system 1000, such as a user of the user device 1300), the dynamic modification being responsive to user input from one or more target users of the set of target users, can include a controller (e.g., the controller 1105) programmed/configured to receive the specification of the interactive dialog (e.g., a serialized specification, such as the vDML specification described herein) for the set of target users, the interactive dialog structured as a directed graph (e.g., see FIG. 3B). The directed graph includes a set of nodes (e.g., the pre-authored/pre-specified nodes of the graph 300′), wherein each node represents content (e.g., a text message, image, and/or the like) to be rendered to that target user via a display device of that target user. The directed graph also includes a set of edges (e.g., the pre-authored/pre-specified edges of the graph 300′), each edge of the set of edges being a directed edge (e.g, the edge 320′) connecting two nodes (e.g., the nodes 305, 325) of the set of nodes, wherein each edge represents an anticipated user response of that target user to the content associated with an origin node (e.g., the node 305) of the two nodes. The content associated with each node of the set of nodes can independently include one or more of a text message, an image, an animated image, a video, and/or a hyperlink.

The controller is further configured to transmit, for rendering, to a first target user of the set of target users via a first user device associated with the first target user, content associated with a first node (e.g., a message associated with the node 305) of the set of nodes, the first node being an origin node for one or more first edges of the set of edges. The controller is further configured to receive, responsive to the rendering of the content associated with the first node at the first user device, a first user input from the first target user via the first user device. The controller is further configured to parse (e.g, via regex analysis, semantic analysis, and/or the like) the first user input to identify whether the first user input maps to any edge of the one or more first edges, and when the first user input does not map to any edge of the one or more first edges (i.e., when the user's response does not match any of the edges), communicating an indication of the content associated with the first node and the first user input to an author device (e.g, the Coach device 1400) of the author user (e.g, the CAgent 1410). In some cases, the parsing the first user input is based on one or more of 1) linear string comparison, 2) regular expression matched comparison, 3) semantic distance, or 4) intention map.

The controller is further configured to receive, from the author user, via the author device, and responsive to the communicating, a specification of an update to the directed graph. The specification of the update includes a specification of a second node (e.g., the node 318, the node 345, and/or the like) to be incorporated into the set of nodes, the second node representing content (e.g., the response provided by the CAgent 1410 to the user device 1300) to be rendered to the first user responsive to the first user input. The specification of the update also includes a specification of a second edge (e.g., the edge 312′) to be incorporated into the set of edges, wherein the first node (e.g., the node 305) is an origin node for the second edge and wherein the second node (e.g., the node 318) is a destination node of the set of edges, the second edge representing the first user input. The controller is further configured to update the directed graph based on the update received from the author user (e.g., updating the vDialog 1150 to include the node 318 and the edge 312′, to include the node 345 and the edge 340′, and/or the like). The controller is further configured to transmit, for rendering, to the first target user via the first target device and responsive to the first user input, content associated with the second node (i.e., providing the CAgent's 1410 manual response to the user device 1300).

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments disclosed herein may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification, unless clearly indicated to the contrary, should be understood to mean “at least one.”

The phrase “and/or,” as used herein in the specification, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of” shall have its ordinary meaning as used in the field of patent law.

As used herein in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for dynamic modification of dialog-based interactive content associated with a set of target users, the dynamic modification being responsive to user input from one or more target users of the set of target users, comprising:
receiving the specification of the interactive dialog for the set of target users, the interactive dialog structured as a directed graph including, for each target user of the set of target users:
a set of nodes, wherein each node represents content to be rendered to that target user via a display device of that target user; and
a set of edges, each edge of the set of edges being a directed edge connecting two nodes of the set of nodes, wherein each edge represents an anticipated user response of that target user to the content associated with an origin node of the two nodes;
transmitting, for rendering, to a first target user of the set of target users via a first user device associated with the first target user, content associated with a first node of the set of nodes, the first node being an origin node for one or more first edges of the set of edges;
receiving, responsive to the rendering of the content associated with the first node at the first user device, a first user input from the first target user via the first user device;
parsing the first user input to identify whether the first user input maps to any edge of the one or more first edges;
when the first user input does not map to any edge of the one or more first edges, communicating an indication of the content associated with the first node and the first user input to an author device of an author user;
receiving, from the author user, via the author device, and responsive to the communicating, a specification of an update to the directed graph including:
a specification of a second node to be incorporated into the set of nodes, the second node representing content to be rendered to the first user responsive to the first user input; and
a specification of a second edge to be incorporated into the set of edges, wherein the first node is an origin node for the second edge and wherein the second node is a destination node of the set of edges, the second edge representing the first user input;
updating the directed graph based on the update received from the author user; and
transmitting, for rendering, to the first target user via the first target device and responsive to the first user input, content associated with the second node.

2. The method of claim 1, further comprising transmitting, for rendering, to a second target user of the set of target users via a second user device associated with the second target user, content associated with the first node of the set of nodes;
receiving, responsive to the rendering of the content associated with the first node, a second user input from the second target user via the second user device;
parsing the second user input to identify whether the second user input maps to any edge of the one or more first edges or to the second edge; and
when the second user input maps to the second edge, transmitting for rendering, to the second target user via the second user device and without any input from the author user, the content associated with the second node.

3. The method of claim 1, wherein the specification of the update to the directed graph further includes a specification of a third edge to be incorporated into the set of edges, wherein the second node is an origin node for the third edge and wherein a third node of the set of edges is a destination node for the third edge.

4. The method of claim 1, wherein the update is a first update, further comprising:
receiving, from the first user device, responsive to the rendering of the content associated with the second node, a third user input from the first target user;
transmitting an indication of the third user input to the author device of the author user;
receiving, from the author user via the author device, a specification of a second update to the directed graph including:
a specification of a fourth node to be incorporated into the set of nodes, the fourth node representing content to be rendered to the first user responsive to the third user input;
a specification of a fourth edge to be incorporated into the set of edges, wherein the second node is an origin node for the second edge and wherein the fourth node is a destination node of the set of edges, the fourth edge representing the third user input; and
optionally, a specification of a fifth edge to be incorporated into the set of edges, wherein the fourth node is an origin node for the fifth edge and wherein a sixth node of the set of edges is a destination node for the fifth edge;
updating the directed graph based on the second update received from the author user;
rendering, to the first target user via the first user device and response to the second user input, content associated with the fourth node.

5. The method of claim 1, wherein the content associated with each node of the set of nodes independently includes one or more of a text message, an image, an animated image, a video, and/or a hyperlink.

6. The method of claim 1, wherein the parsing the first user input is based on one or more of 1) linear string comparison, 2) regular expression matched comparison, 3) semantic distance, or 4) intention map.

7. The method of claim 1, wherein the dialog is a first dialog of a set of dialogs, further comprising executing each dialog of the set of dialogs based on a predetermined order associated with the first user.

8. The method of claim 7, wherein the order further specifies an order of execution for each module of a set of modules, each module of the set of modules including a user interface for display to the first user.

9. The method of claim 8, wherein the user interface for at least one module of the set of modules is dynamically generated by:
receiving a first specification of a user interface element to be rendered on that user interface, wherein the specification of the user interface element includes one or more first user interface keywords, wherein the set of modules is associated with one or more user parameters of the first user;
identifying a first set of payload elements as associated with the user interface element and deemed selectable for rendering as the user interface element on that user interface, each payload element including a specification of:
one or more payload keywords;
selection logic; and
a payload weight;
filtering the first set of payload elements based on comparing the one or more payload keywords of each payload element of the first set of payload elements against the one or more user interface keywords to generate a second set of payload elements;
filtering the second set of payload elements based on comparing the selection logic of each payload element of the second set of payload elements against the one or more user parameters to generate a third set of payload elements;
selecting, via weighted random selection, a selected first payload element from the third set of payload elements based on the payload weight of each payload element of the third set of payload elements; and
rendering that user interface on the display of the display device with the selected first payload element as the user interface element.

10. The method of claim 8, further comprising modifying the order of execution based on the first user input.

11. The method of claim 8, wherein the order of execution includes timing information for execution of each dialog of the set of dialogs and for execution of each module of the set of modules.

12. The method of claim 11, further comprising modifying the timing information based on the first user input.

13. The method of claim 1, wherein the specification of the dialog is a serialized representation of the dialog.

14. The method of claim 1, wherein the update is a first update, further comprising:
receiving, from the author user via the author device, a specification of a second update to the directed graph, the second update including one or more of:
a specification of one or more nodes to be removed from the set of nodes;
a specification of one or more edges to be removed from the set of edges; or
a specification of two or more edges of the set of edges to be merged; and
updating the directed graph based on the second update.

15. The method of claim 1, wherein at least one node of the set of nodes includes an indication to communicate the content associated with that at least one node to the author device of the author user, further comprising communicating the content associated with that at least one node to the author device of the author user.

16. A system for dynamic modification of dialog-based interactive content associated with a set of target users, the dynamic modification being responsive to user input from one or more target users of the set of target users, the system comprising a controller configured to:
receive the specification of the interactive dialog for the set of target users, the interactive dialog structured as a directed graph including, for each target user of the set of target users:
a set of nodes, wherein each node represents content to be rendered to that target user via a display device of that target user; and
a set of edges, each edge of the set of edges being a directed edge connecting two nodes of the set of nodes, wherein each edge represents an anticipated user response of that target user to the content associated with an origin node of the two nodes;
transmit, for rendering, to a first target user of the set of target users via a first user device associated with the first target user, content associated with a first node of the set of nodes, the first node being an origin node for one or more first edges of the set of edges;
receive, responsive to the rendering of the content associated with the first node at the first user device, a first user input from the first target user via the first user device;
parse the first user input to identify whether the first user input maps to any edge of the one or more first edges;
when the first user input does not map to any edge of the one or more first edges, communicate an indication of the content associated with the first node and the first user input to an author device of an author user;
receive, from the author user, via the author device, and responsive to the communicating, a specification of an update to the directed graph including:
a specification of a second node to be incorporated into the set of nodes, the second node representing content to be rendered to the first user responsive to the first user input; and
a specification of a second edge to be incorporated into the set of edges, wherein the first node is an origin node for the second edge and wherein the second node is a destination node of the set of edges, the second edge representing the first user input;
update the directed graph based on the update received from the author user; and
transmit, for rendering, to the first target user via the first target device and responsive to the first user input, content associated with the second node.

17. The system of claim 16, wherein the controller is further configured to
transmit, for rendering, to a second target user of the set of target users via a second user device associated with the second target user, content associated with the first node of the set of nodes;
receive, responsive to the rendering of the content associated with the first node, a second user input from the second target user via the second user device;
parse the second user input to identify whether the second user input maps to any edge of the one or more first edges or to the second edge; and
when the second user input maps to the second edge, transmit for rendering, to the second target user via the second user device and without any input from the author user, the content associated with the second node.

18. The system of claim 17, wherein the specification of the update to the directed graph further includes optionally, a specification of a third edge to be incorporated into the set of edges, wherein the second node is an origin node for the third edge and wherein a third node of the set of edges is a destination node for the third edge.

19. The system of claim 16, wherein the update is a first update, wherein the controller is further configured to:
receive, from the first user device, responsive to the rendering of the content associated with the second node, a third user input from the first target user;
transmit an indication of the third user input to the author device of the author user;
receive, from the author user via the author device, a specification of a second update to the directed graph including:
a specification of a fourth node to be incorporated into the set of nodes, the fourth node representing content to be rendered to the first user responsive to the third user input;
a specification of a fourth edge to be incorporated into the set of edges, wherein the second node is an origin node for the second edge and wherein the fourth node is a destination node of the set of edges, the fourth edge representing the third user input; and
optionally, a specification of a fifth edge to be incorporated into the set of edges, wherein the fourth node is an origin node for the fifth edge and wherein a sixth node of the set of edges is a destination node for the fifth edge;
update the directed graph based on the second update received from the author user;
render, to the first target user via the first user device and response to the second user input, content associated with the fourth node.

20. The system of claim 16, wherein the content associated with each node of the set of nodes independently includes one or more of a text message, an image, an animated image, a video, and/or a hyperlink.

21. The system of claim 16, wherein the controller is further configured to parse the first user input based on one or more of 1) linear string comparison, 2) regular expression matched comparison, 3) semantic distance, or 4) intention map.

22. The system of claim 16, wherein the dialog is a first dialog of a set of dialogs, wherein the controller is further configured to execute each dialog of the set of dialogs based on a predetermined order associated with the first user.

23. The system of claim 22, wherein the order further specifies an order of execution for each module of a set of modules, each module of the set of modules including a user interface for display to the first user.

24. The system of claim 22, wherein the controller is further configured to modify the order of execution based on the first user input.

25. The system of claim 22, wherein the order of execution includes timing information for execution of each dialog of the set of dialogs and for execution of each module of the set of modules.

26. The system of claim 22, wherein the controller is further configured to modify the timing information based on the first user input.
